(19) United States
(12) Patent Application Publication
(10) Pub. No.: US 2026/0236550 A1
(43) Pub. Date: Aug. 13, 2026

(54) CONTROL METHOD FOR INFORMATION PROCESSING APPARATUS, INFORMATION PROCESSING APPARATUS, AND STORAGE MEDIUM

(71) Applicant: CANON KABUSHIKI KAISHA, Tokyo (JP)

(72) Inventor: KENTA MIYAO, Tokyo (JP)

(21) Appl. No.: 19/530,530

(22) Filed: Feb. 5, 2026

(30) Foreign Application Priority Data
Feb. 12, 2025 (JP) 2025-021052

(51) Int. Cl. G06F 16/957; G06F 16/955; G06F 16/958; G06F 40/14; H04N 1/00

(52) U.S. Cl. CPC G06F 16/9577; G06F 16/9566; G06F 16/986; G06F 40/14; H04N 1/00464

(57) ABSTRACT

A control method for an information processing apparatus performed by executing an application configured to provide a browser function, the control method including: receiving information on a first web page displayed by a second web browser different from a first web browser provided by the application and information on a second web page displayed by the second web browser before the first web page; displaying the first web page using the first web browser based on the received information on the first web page; and based on selection of a predetermined object displayed with the first web page, displaying the second web page using the first web browser based on the information on the second web page, wherein the application is an application launched based on a predetermined operation being performed in the second web browser.

### BACKGROUND

### Field of the Technology

The present disclosure relates to a control method for an information processing apparatus, an information processing apparatus, and a storage medium.

### Description of the Related Art

Web browsers can save information such as credentials and browsing histories on websites using mechanisms such as cookies. Further, web browsers can utilize the saved information to provide comfortable browsing of websites to users. The Literature (Japanese Patent Laid-Open No. 2013-222440) discloses a technique for using a web browser to share credentials and the like with other applications.

There is a need for a technique to reduce the deterioration of usability that occurs in the use of applications.

### SUMMARY

A control method for an information processing apparatus according to one aspect of the present disclosure is a control method for an information processing apparatus performed by executing an application configured to provide a browser function, the control method comprising: receiving information on a first web page displayed by a second web browser different from a first web browser provided by the application and information on a second web page displayed by the second web browser before the first web page; displaying the first web page using the first web browser based on the received information on the first web page; and based on selection of a predetermined object displayed with the first web page, displaying the second web page using the first web browser based on the information on the second web page, wherein the application is an application launched based on a predetermined operation being performed in the second web browser.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of a configuration of a system according to the present disclosure;

FIG. 2 is a block diagram showing an example of a hardware configuration of a web server;

FIG. 3 is a block diagram showing an example of hardware configurations of a printer and a client terminal;

FIG. 4 is a block diagram showing an example of a software configuration of the client terminal;

FIG. 5A is a diagram showing an example of a window displayed by a standard preferences application;

FIG. 5B is a diagram showing an example of a window on which a connected printer list is displayed;

FIG. 6 is a diagram showing an example of a configuration of a custom URL scheme;

FIG. 7A is a flowchart showing an example of processing performed by the web browser;

FIG. 7B is a flowchart showing an example of processing performed by the printer portal application;

FIG. 8 is a diagram showing an example of a content page displayed on the web browser;

FIG. 9 is a diagram showing an example of a UI screen in displaying the content page on an in-app browser of the printer portal application;

FIG. 10 is a diagram showing an example of a print dialog 1000;

FIG. 11A is a flowchart showing an example of processing performed by the web browser;

FIG. 11B is a flowchart showing an example of processing performed by the printer portal application;

FIG. 12 is a diagram showing an example of hierarchy information of a content selection site;

FIG. 13A is a flowchart showing an example of processing performed by the web browser;

FIG. 13B is a flowchart showing an example of processing performed by the printer portal application; and

FIG. 14 is a diagram showing an example of a transition destination selection screen.

### DESCRIPTION OF THE EMBODIMENTS

The following will describe preferred embodiments of the present disclosure with reference to the accompanying drawings. Note that the following embodiments do not limit the matters of the present disclosure, and not all of the combinations of features described in the following embodiments are required for the solutions of the present disclosure. Note that the same configuration will be described with the same reference numeral.

Conventionally, web browsers such as Safari, Microsoft Edge, and Google Chrome have been able to save information such as credentials and browsing histories on websites using mechanisms such as cookies. Further, these web browsers can utilize the saved information to provide comfortable browsing of websites to users.

Further, the states of pages can also be saved in a web browser as history information. As a result, in a case where a user performs an operation to return to the previous page, the web browser can refer to the user's activity history information and move to the page displayed just before, or restore the state such as the scroll position and the form input contents of that page.

In recent years, there has appeared a function that, in a case where a user performs a specific operation (such as selecting a content they want to print) while browsing a website on a web browser, launches a predetermined application in conjunction with the specific operation. Further, there have also appeared applications equipped with a function to allow browsing websites within a predetermined application. Hereinafter, a function to browse websites equipped in an application will be referred to as an "in-app browser".

With the appearance of such a function, a method for sharing information such as a browsing history of a web browser with other applications is expected in order to also browse websites comfortably on in-app browsers as on web browsers.

A class for operating a class for in-app browsers (Safari View Controller) in the system (e.g., iOS) is provided as a system API. This allows in-app browsers to share history information and the like of a web browser provided by the vendor of the OS (operating system) using this API.

Further, for a web browser that is other than the web browser provided by the OS vendor and is provided by a third party, the third party prepares a dedicated server for sharing information. This allows in-app browsers to share history information and the like of a web browser provided by a third party through this dedicated server.

However, in recent years, privacy protection has been considered more important around the world, and there is a need for more privacy-aware methods to share credentials and browsing histories. For example, overseas, there is a trend to partially restrict the sharing of information such as credentials and browsing histories between web browsers and in-app browsers from the perspective of privacy protection. In such a situation, it is expected that conventional methods (e.g., APIs provided by OS vendors or dedicated servers provided by third parties) cannot share credentials, browsing histories, and the like between web browsers and in-app browsers.

In association with this, there is a possibility that the function to return to the previous page based on the browsing history of a web browser cannot be used on an in-app browser of an application that is cooperatively launched from the web browser, deteriorating the usability.

For example, a first page of a website is opened on a web browser and thereafter a second page of that website is opened. After an application is launched in response to a specific operation on the second page being displayed on the web browser, the second page is displayed on an in-app browser of the application. Then, the user expects to return from the second page to the first page by pressing a button for returning to the previous page provided on the in-app browser, but information on the first page is not shared as browsing information, causing a situation where it is not possible to return to the first page.

The following will describe a technique for reducing the deterioration of usability even under this restriction by reproducing the function to return to the previous page on an in-app browser in a pseudo manner.

### First Embodiment

### Configuration of This System

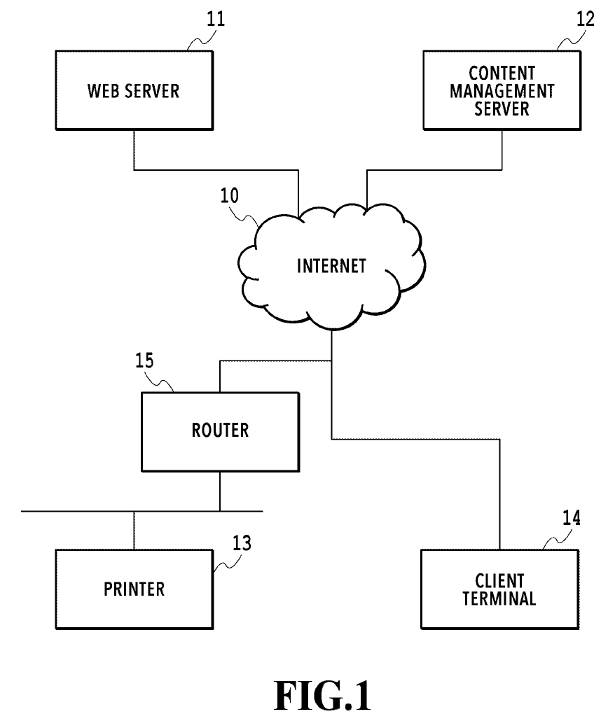

FIG. 1 is a diagram showing an example of a configuration of a system in this embodiment. Referring to FIG. 1, as shown in FIG. 1 which describes a configuration of a system according to the present disclosure, the system according to the present disclosure includes a web server 11, a content management server 12, a printer 13 as an image recording apparatus, and a client terminal 14.

The web server 11, the content management server 12, and the client terminal 14 can be connected to the Internet 10. The printer 13 can be connected to the Internet 10 via a router 15. The client terminal 14 can transmit and receive information to and from the web server 11, the content management server 12, and the printer 13 over the Internet 10. Specifically, the client terminal 14 can transmit and receive information to and from other apparatuses that constitute the system according to the present disclosure using a protocol such as HTTP or XMPP. Note that protocols other than the above protocols may be used to communicate information.

The web server 11 holds and manages page information on pages that constitute websites it provides. Further, the web server 11 can provide part or all of the page information it holds according to requests from other apparatuses. The page information includes images on pages that constitute websites, screen IDs (screen information) to uniquely identify the pages, and URLs (Uniform Resource Locators) of contents corresponding to the pages.

The content management server 12 holds and manages contents (e.g., image contents). The content management server 12 can provide contents corresponding to content URLs received from other apparatuses.

### Hardware Configuration of Server

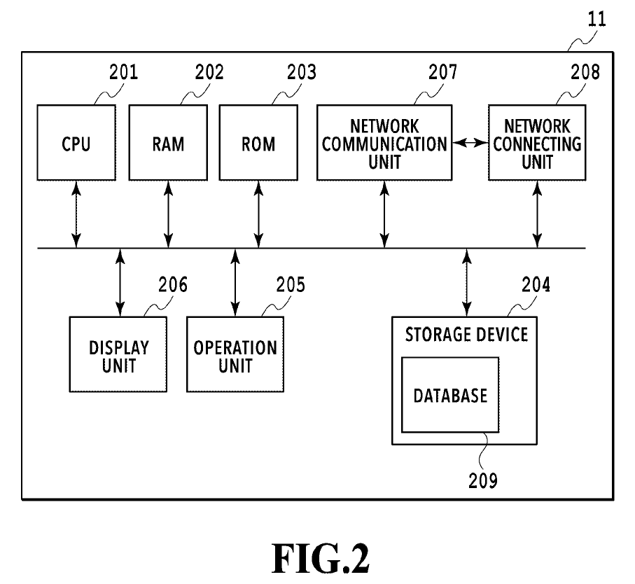

FIG. 2 is a block diagram showing an example of a hardware configuration of the web server 11. A configuration of the web server 11 will be described with reference to FIG. 2. The web server 11 includes a CPU 201, a RAM 202, a ROM 203, a storage device 204, an operation unit 205, a display unit 206, a network communication unit 207, and a network connecting unit 208. These are connected to each other via a system bus. The storage device 204 includes a database 209. The database 209 includes information on websites, web pages that constitute the websites, information on contents that can be provided to other apparatuses, and the like.

The CPU 201 controls the entire web server 11. The RAM 202 is a main memory for the CPU 201 and is used as a working memory to temporarily store data such as programs. The ROM 203 is a read-only memory that stores boot programs required to boot the system of the web server 11.

The storage device 204 stores programs executed by the CPU 201, the database 209, and various types of information. The storage device 204 is a non-volatile storage device, such as a magnetic disk or a flash memory.

The operation unit 205 includes an input device for a user to perform various input operations. The input device includes, for example, a keyboard or a mouse. The display unit 206 is composed of, for example, LEDs or liquid crystal, and displays various types of information. The network communication unit 207 is connected to a network such as the Internet 10 via the network connecting unit 208 and performs various types of communication.

Note that since the content management server 12 has the same hardware configuration as that of the web server 11, the description thereof is omitted. However, the content management server 12 may have a hardware configuration different from that of the web server 11.

### Hardware Configurations of Printer and Client Terminal

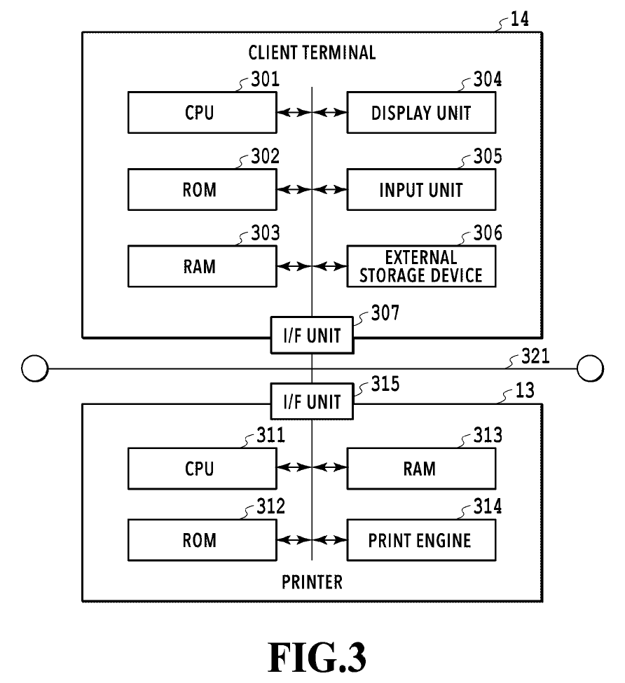

FIG. 3 is a block diagram showing an example of hardware configurations of the printer 13 and the client terminal 14. Hardware configurations of the printer 13 and the client terminal 14 will be described with reference to FIG. 3

The client terminal 14 and the printer 13 are communicably connected together via communication bus 321 such as an Ethernet (R), USB, or the like. In FIG. 3, an example of a single printer 13 will be described. Note that two or more printers may be connected to the client terminal 14 via the communication bus 321.

The client terminal 14 is a type of information processing apparatus. An OS is installed in the client terminal 14. The OS includes an OS standard printing function unit 402, which is OS standard printing software described later.

The client terminal 14 is, for example, a personal computer (PC), which includes a CPU 301, a ROM 302, a RAM 303, a display unit 304, an input unit 305, an external storage device 306, and an interface (I/F) unit 307. Note that the client terminal 14 is not limited to a desktop PC, but may be a notebook PC, a tablet PC, or a smartphone. The client terminal 14 can transmit instructions to control the printer 13, print data, configuration commands, and the like to the printer 13.

The CPU 301 controls the entire client terminal 14. Further, the CPU 301 also executes the OS and control programs such as an OS print data conversion utility described later. The ROM 302 stores boot programs required to boot the client terminal 14. The RAM 303 is a main memory for the CPU 301 and is used as a working memory to temporarily store data such as programs.

The display unit 304 is a display device that displays information input from the input unit 305, user interface screens of the OS and applications, messages, or the like. The input unit 305 is an input device such as a keyboard or a mouse for operating the client terminal 14.

The external storage device 306 stores applications and various control programs such as the OS print data conversion utility. The I/F unit 307 is a communication module that transmits and receives data to and from the printer 13.

The printer 13 is an example of an image recording apparatus, such as an inkjet printer. The printer 13 includes a CPU 311, a ROM 312, a RAM 313, a print engine 314, and an I/F unit 315.

The CPU 311 controls the entire printer 13. The ROM 312 is a read-only memory, and stores programs for controlling the print engine 314 and the like. The RAM 313 is a working memory for temporarily storing programs necessary for the operation of the print engine 314 and data such as setting values received from the client terminal 14.

The print engine 314 performs recording on a recording medium based on print data transmitted from the client terminal 14. The I/F unit 315 is a communication module that receives print data from the client terminal 14, and has, for example, a function to transmit current status information of the printer 13 from the printer 13 to the client terminal 14.

The status information is status data that represents the status of the printer 13. The status information is returned by the printer 13 to the client terminal 14 on a request from the client terminal 14 connected to the printer 13 via the I/F unit 315. The status data includes information for informing the operating status of the printer 13, such as "printing" or "idle", as well as the error status of the printer 13, such as "out of paper", "cover open", or "no consumables left". Furthermore, the status data also includes information such as the type of consumables being attached, the display color of each consumable, and the remaining amount value of each consumable.

### Software Configuration of Client Terminal

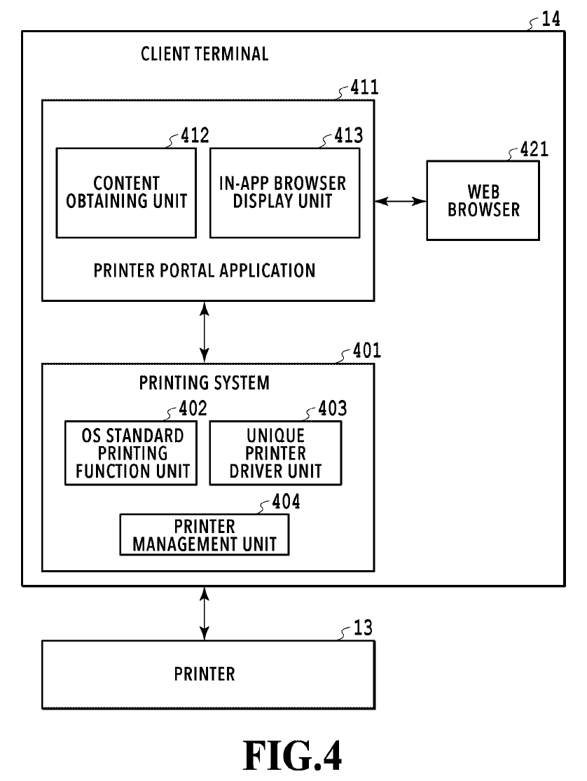

FIG. 4 is a block diagram showing an example of a software configuration of the client terminal 14. A software configuration of the client terminal 14 will be described with reference to FIG. 4. The client terminal 14 is equipped with a web browser 421 for providing a function to browse websites over the Internet 10. Furthermore, the client terminal 14 is equipped with a printing system 401 for providing a printing function.

The printing system 401 is operably equipped with the OS standard printing function unit 402, a unique printer driver unit 403, and a printer management unit 404.

The OS standard printing function unit 402 or the unique printer driver unit 403 is software for converting data output by applications into data that can be printed by the printer 13 and causing the printer 13 to perform printing based on the data.

The OS standard printing function unit 402 is software that is equipped in the OS as standard, and is software that allows printing without installing a vendor-specific printer driver. On the other hand, the unique printer driver unit 403 is software provided by each printer vendor, and is software that is equipped with optimum functions for enhancing the printing functions of a printer provided by that vendor.

Using a printer on the printing system 401 requires registration of the printer in the printer management unit 404. This registration process is performed on a per-printer or per-connection form basis. For example, even in a case of the same printer, it is registered and managed in the printer management unit 404 separately in each of the case of USB connection or the case of network connection.

In addition, the client terminal 14 is equipped with a printer portal application 411. The printer portal application 411 includes a content obtaining unit 412, an in-app browser display unit 413, and the like.

The printer portal application 411 is software that performs the obtaining of information on the printer 13, printing, scanning, or the like according to user instructions and the connection state of the printer 13. The printer portal application 411 is an application that can be launched in response to a launch instruction described later from the web browser 421.

The content obtaining unit 412 has a function to obtain content information in response to a predetermined user operation performed on a website that can be browsed on the in-app browser display unit 413 or the web browser 421. The in-app browser display unit 413 has a function to browse websites and the like on the in-app browser using WebView. In other words, the in-app browser display unit 413 has a function to perform control for displaying pages of websites.

### Screens Provided by Printer Management Unit of Printing System

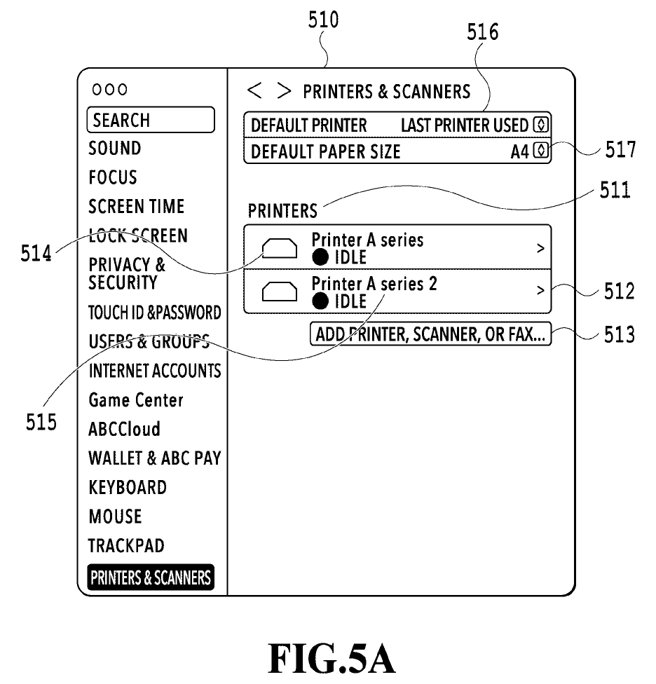

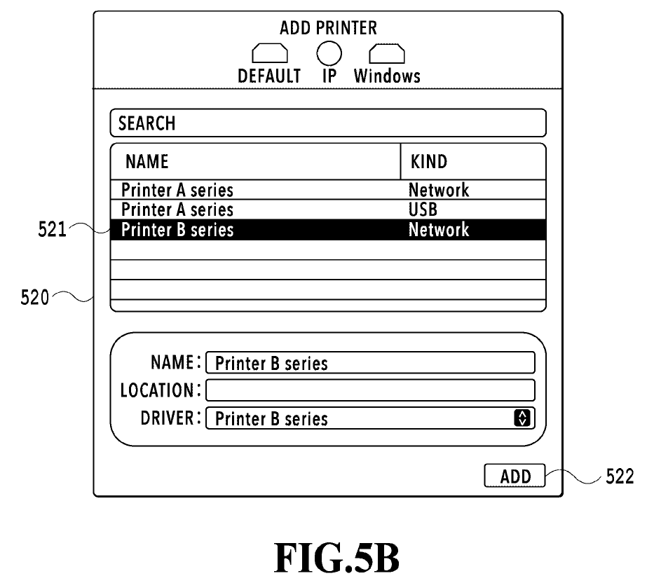

An outline of the printer management unit 404 of the printing system 401 in this embodiment will be described. FIGS. 5A and B are diagrams showing examples of screens provided by the printer management unit 404 of the printing system 401. FIG. 5A is a diagram showing an example of a window displayed by a standard preferences application running on an OS (e.g., Mac OS (R) from Apple Inc., U.S.A.) in response to a user operation.

The window 510 shown in FIG. 5A displays a printer list 511. In the printer list 511, a registration button 513 is provided, and a printer preview part 514 and a printer information part 515 are displayed. The window 510 is provided with a default printer setting part 516 and a default paper size setting part 517. Note that a button may be described as an item that receives a predetermined instruction.

In a case of registering a printer in the printing system, the user presses the registration button 513. In a case where the registration button 513 is pressed, a window 520 shown in FIG. 5B is displayed. FIG. 5B is a diagram showing an example of the window 520 on which a connected printer list is displayed. The window 520 has a connected printer list 521 displayed thereon and has an add button 522 provided thereon.

Printers currently connected to the client terminal 14 are displayed in the connected printer list 521. In this case, if a printer supports a plurality of connection forms, the printer is displayed separately for each connection form.

For example, a printer that supports network connection and USB connection is displayed in the connected printer list 521 for each connection form of network connection and USB connection. In a case where the user selects a desired printer from among them and presses the add button 522, a printer registration process is performed in the printer management unit 404. In a case where the printer registration process is successful, the window 520 is closed and a registered printer queue is added to a region 512 surrounded by the frame of the printer list 511 in the window 510.

The printers shown in the printer list 511 are printer queues registered in the printing system 401, and are printers that can perform printing and scanning. In a case where the user selects a printer to use from the printer list 511, a preview image indicating the selected printer is displayed in the printer preview part 514. Further, the printer information part 515 displays information indicating the printer status (idle).

### Configuration of Custom URL Scheme

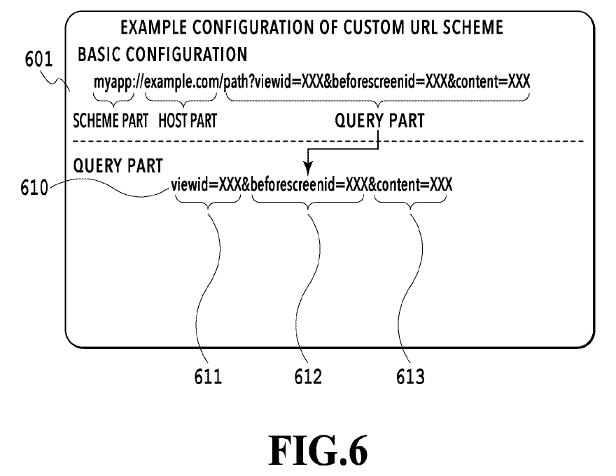

FIG. 6 is a diagram showing an example of a configuration of a custom URL scheme. The custom URL scheme will be described with reference to FIG. 6. The custom URL scheme is a function that utilizes a unique URL scheme to launch an application directly. A custom URL scheme in this embodiment conforms to the basic structure of the uniform resource identifier (URI) in RFC 3886. Thus, as shown in FIG. 6, the custom URL scheme consists of the scheme part, the host part, and the query part.

The scheme part indicates a protocol name that defines a way to access the resource indicated by a URI, and is a character string that can be set for each application to be launched. The host part is a character string that indicates the hostname or IP address where the resource is located. Further, the host part may also include a path name that indicates the location of the resource.

The query part is a character string that indicates information on the resource. The query part 610 includes a screen ID 611 of a page being displayed on a web browser, a screen ID 612 of the page one page before the screen being displayed and print content information 613. Note that the query part may include information items other than these information items. In other words, the query part is a part where any information items can be added as parameters after the scheme part and the host part. The web browser can pass specific information to the application by including information such as such screen IDs of pages in an application launch instruction (custom URL scheme) described later.

### Processing in Web Browser and Printer Portal Application

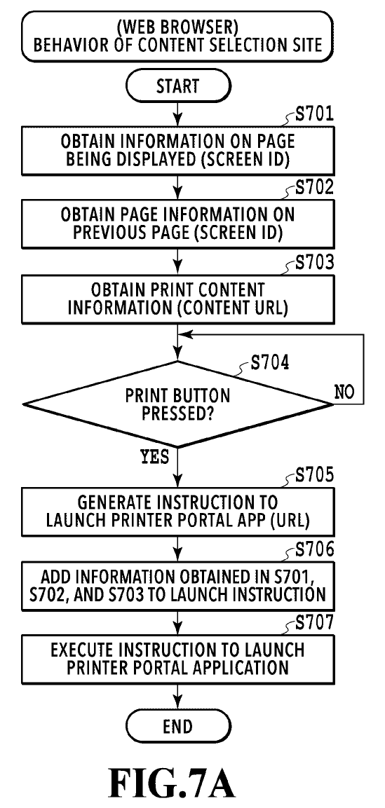

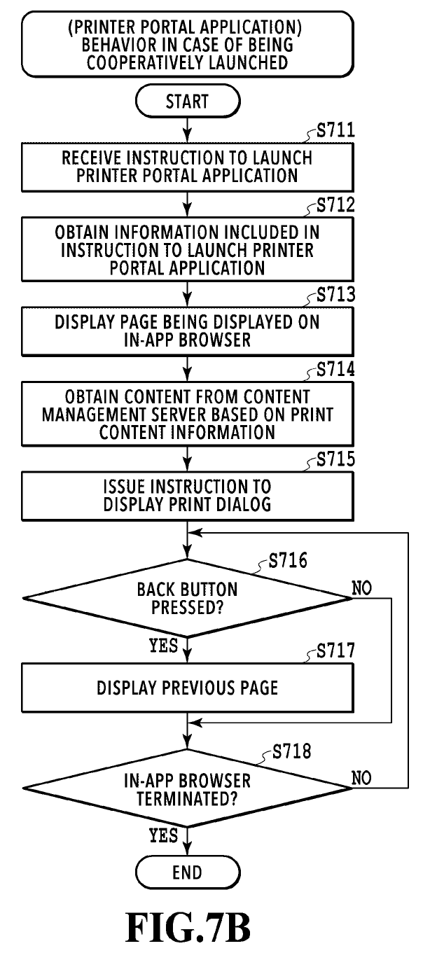

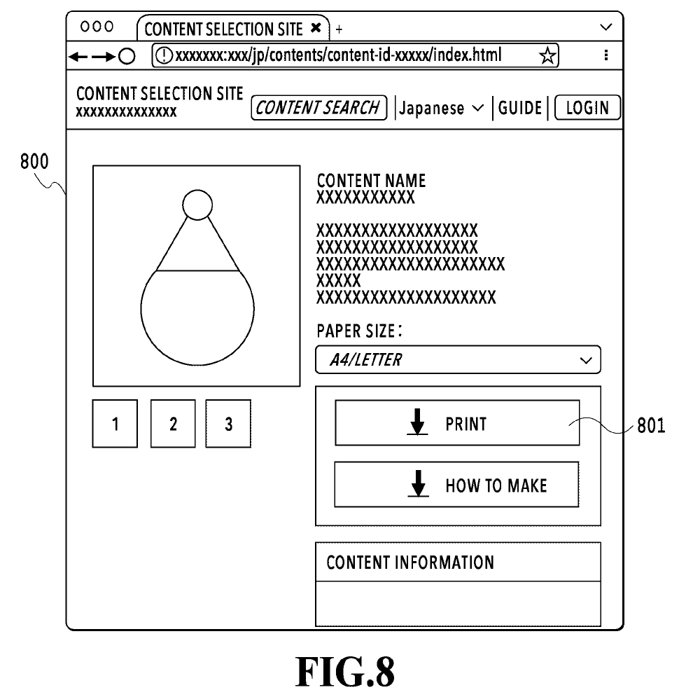

FIGS. 7A and 7B are flowcharts showing an example of processing in the web browser 421 and the printer portal application 411 in this embodiment. Before the detailed description of FIGS. 7A and B, FIGS. 8 to 10 will be described. FIG. 8 is a diagram showing an example of a page displayed on the web browser 421, which is a page of content that is one page in a site where a content to be printed can be selected from a plurality of contents (hereinafter referred to as a content selection site). A page of content (hereinafter referred to as a content page) is, for example, a page that is displayed after a content to be printed (hereinafter referred to as a "print content") is selected by the user in the content selection site.

A content page 800 shown in FIG. 8 is provided with a print button 801 that receives an instruction to print a selected print content. By the user pressing the print button 801, a custom URL scheme corresponding to the printer portal application 411 is executed (a launch instruction is executed), and the printer portal application 411 is launched.

Since the printer portal application 411 is equipped with an in-app browser using WebView, the user can browse the content page 800 using the printer portal application 411 launched based on the launch instruction.

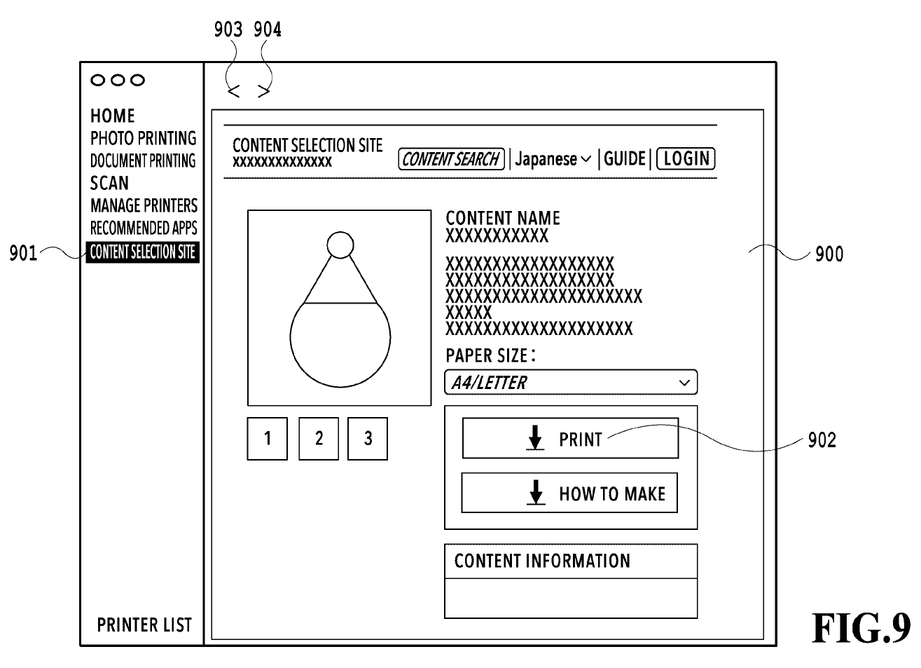

FIG. 9 is a diagram showing an example of a UI screen in a case where a content page of the content selection site is displayed on the in-app browser of the printer portal application 411. A sidebar in the UI screen shown in FIG. 9 is provided with a content selection site display button 901. By the user pressing the content selection site display button 901, a content page 900 of the content selection site shown in FIG. 9 is displayed on the in-app browser. Further, in a case where the printer portal application 411 is launched based on the launch instruction, the content page 900 can be displayed on the in-app browser in the state shown in FIG. 9 without the user's press operation on the content selection site display button 901. The content page 900 corresponds to the content page 800 displayed by the web browser 421.

The content page 900 is provided with a print button 902. The print button 902 is a button for receiving an instruction to open a print dialog described later on the printer portal application 411. In a case where the user presses the print button 902, a print dialog 1000 for printing the print content corresponding to the content page displayed by the in-app browser is displayed.

A back button 903 and a forward button 904 are provided on the in-app browser of the printer portal application 411. The back button 903 is a button for receiving an instruction to move to the page one page before the page being displayed by the in-app browser. The forward button 904 is a button for receiving an instruction to move to the page one page after the page being displayed by the in-app browser.

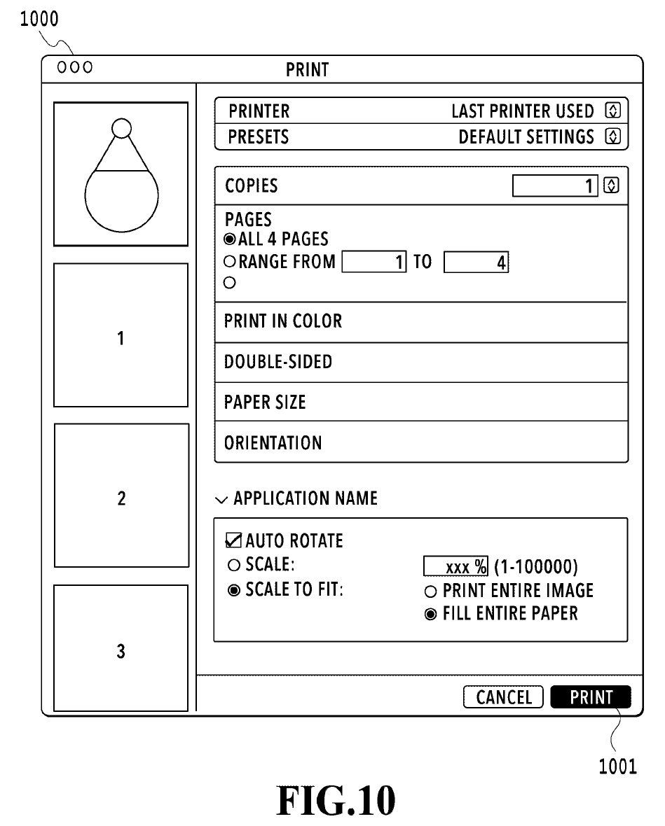

FIG. 10 is a diagram showing an example of the print dialog 1000 for printing the print content corresponding to the content page 900 displayed on the in-app browser. The print dialog 1000 is provided with a print button 1001. By the user pressing the print button 1001, an instruction to print the print content is transmitted to the printer 13. Note that the print dialog 1000 shown in FIG. 10 is displayed by the OS of the client terminal 14.

A technique for reducing the deterioration of usability by reproducing the function to return to the previous page in a pseudo manner even in an environment where history information cannot be shared between the web browser 421 and the in-app browser will be described with reference to FIG. 7 to FIG. 10.

FIG. 7A is a diagram showing an example of processing performed by the web browser 421. The processing shown in FIG. 7A is implemented by the CPU 301 of the client terminal 14 reading the program of the web browser 421 stored in the ROM 302 to the RAM 303 and the CPU 301 of the client terminal 14 executing the program. Note that the functions of some or all of the steps in FIG. 7A may be implemented with hardware such as ASICs or electronic circuits. The symbol "S" in the description of each process means a step in the flowchart diagram (hereinafter the same applies to flowchart diagrams in this specification). The flowchart shown in FIG. 7A is started by the web browser 421 displaying the content page 800. A flow of launching the printer portal application 411 from the content page displayed on the web browser 421 will be described with reference to FIG. 7A.

In S701, the CPU 301 causes the web browser 421 to obtain the screen ID of the content page of the content selection site being displayed (e.g., the content page 800) from the web server 11 and proceeds to S702. Note that the screen ID of the content page being displayed on the web browser 421 obtained in S701 refers to a screen ID managed on the web server 11 to display a page that constitutes the content selection site.

In S702, the CPU 301 causes the web browser 421 to obtain the screen ID of the page one page before the content page of the content selection site being displayed (hereinafter referred to as the previous page) from the web server 11, and proceeds to S703. The screen ID of the previous page is also a screen ID managed on the web server 11, just like the screen ID obtained in S701 mentioned above.

In S703, the CPU 301 causes the web browser 421 to obtain information on the print content corresponding to the content page of the content selection site (hereinafter referred to as print content information) from the web server 11, and proceeds to S704. The print content information is a URL that indicates the location of a print content managed by the content management server 12. Note that the print content information may be a print content ID for uniquely identifying a print content on the content management server 12.

In S704, the CPU 301 causes the web browser 421 to determine whether the print button 801 on the content page 800 as shown in FIG. 8 has been pressed. In S704, if the CPU 301 causes the web browser 421 to determine that the print button 801 has been pressed by the user (Yes), it proceeds to S705. In S704, if the CPU 301 causes the web browser 421 to determine that the print button 801 has not been pressed by the user (No), it returns to S704 and continues to determine whether the print button 801 has been pressed.

In S705, the CPU 301 causes the web browser 421 to generate a URL as a launch instruction to launch the printer portal application 411, and proceeds to S706. Note that the URL generated in S705 is expressed with a custom URL scheme described above, and the scheme part includes a character string corresponding to the printer portal application 411.

In S706, the CPU 301 causes the web browser 421 to add the screen ID of the content page being displayed obtained in S701, the screen ID of the previous page obtained in S702, and the print content information obtained in S703 to the URL generated in S705. In other words, in S706, the CPU 301 causes the web browser 421 to include the screen ID obtained in S701, the screen ID obtained in S702, and the print content information obtained in S703 in the launch instruction as parameters, and proceeds to S707.

An example configuration of the URL after the information obtained in S701 to S703 is added to the URL generated in S705 will be described with reference to the query part 610 in FIG. 6. The screen ID obtained in S701 is stored in the "XXX" portion of the screen ID 611 of the query part 610 in FIG. 6. The screen ID obtained in S702 is stored in the "XXX" portion of the screen ID 612 of the query part 610 in FIG. 6. The print content information obtained in S703 is stored in the "XXX" portion of the print content information 613 of the query part 610 in FIG. 6.

In S707, the CPU 301 causes the web browser 421 to execute the launch instruction and ends this flow. Note that the launch instruction in S707 is a launch instruction with the above information added thereto in S706, and is a custom URL scheme for launching the printer portal application 411.

The flowchart in FIG. 7B will be described. FIG. 7B is a flowchart showing an example of processing performed by the printer portal application 411. A flow in which the printer portal application 411 launched in response to the launch instruction issued by the web browser 421 displays the previous page will be described with reference to FIG. 7B.

The processing shown in FIG. 7B is implemented by the CPU 301 of the client terminal 14 reading the program of the printer portal application 411 stored in the ROM 302 to the RAM 303 and the CPU 301 of the client terminal 14 executing the program. Note that the processing shown in FIG. 7B is started in response to the printer portal application 411 being launched by the OS implemented in the client terminal 14 using the function of the custom URL scheme.

In S711, the CPU 301 causes the printer portal application 411 to receive the launch instruction corresponding to the custom URL scheme handed over from the OS in a case where it is launched, and proceeds to S712. Note that the launch instruction in S711 has been executed by the web browser 421 in S707 in FIG. 7A.

In S712, the CPU 301 causes the printer portal application 411 to obtain the information included in the launch instruction received in S711, and proceeds to S713. The information included in the launch instruction is, specifically, "the screen ID 611 of the page being displayed on the web browser 421", "the screen ID 612 of the previous page ", and "the print content information 613" included in the query part of the custom URL scheme. Thus, in S712, the CPU 301 can cause the printer portal application 411 to extract and obtain each information item included in the launch instruction received in S711.

In S713, the CPU 301 causes the printer portal application 411 to display the page linked to the screen ID of the page being displayed on the web browser obtained in S712 on the in-app browser and proceeds to S714. As an example of a way to display the page in S713, a screen ID is included in the URL of the content selection site, and by replacing the screen ID with the screen ID of the page being displayed on the web browser obtained in S712, the page can be displayed. In other words, the printer portal application 411 obtains from the web server 11, the page corresponding to the URL obtained by replacing the screen ID included in the URL of the content selection site with the screen ID of the page being displayed on the web browser obtained in S712. Then, the printer portal application 411 displays the page obtained from the web server 11. Note that the way to display the page is not limited to this.

For example, a table with screen IDs and their corresponding URLs is uploaded to the web server 11. The printer portal application 411 transmits the screen ID of the page being displayed on the web browser obtained in S712 to the web server 11. Then, the web server 11 refers to the table to identify the URL corresponding to the screen ID received from the printer portal application 411. Thereafter, the printer portal application 411 may obtain the page linked to the identified URL from the web server 11 and display it.

In S714, the CPU 301 causes the printer portal application 411 to obtain the print content that corresponds to the print content information obtained in S712 and is managed by the content management server 12. Then, in a case where the CPU 301 causes the printer portal application 411 to obtain the print content from the content management server 12 in S714, it proceeds to S715. Note that although obtaining the print content from the content management server 12 based on the print content information which is a URL has been described as an example, the way to obtain the print content is not limited to this.

For example, a table with print content IDs and their corresponding URLs is uploaded to the content management server 12. The print content ID is added to the launch instruction instead of the URL indicating the location of the print content as the print content information, and the printer portal application 411 is launched in response to the launch instruction. Then, the printer portal application 411 transmits the print content ID obtained in S712 to the content management server 12. Then, the content management server 12 refers to the table to identify the URL corresponding to the print content ID received from the printer portal application 411. Thereafter, the printer portal application 411 may obtain the print content linked to the identified URL from the web server 11.

In S715, the CPU 301 causes the printer portal application 411 to instruct the OS to display the print dialog 1000 to print the print content obtained in S714 and proceeds to S716. Then, in S715, the CPU 301 causes the OS to display the print dialog 1000 according to the instruction from the printer portal application 411. The print dialog 1000 is displayed, for example, on top of the in-app browser.

After this, the CPU 301 causes the OS to transmit a print execution instruction to the printer 13 in a case of detecting a press of the print button 1001 on the print dialog 1000. Then, the CPU 301 closes the print dialog 1000 in a case where the OS completes transmission of the print execution instruction to the printer 13.

In S716, the CPU 301 causes the printer portal application 411 to determine whether the back button 903 has been pressed. In S716, if the CPU 301 causes the printer portal application 411 to determine that the back button 903 has been pressed (Yes), it proceeds to S717. In S716, if the CPU 301 causes the printer portal application 411 to determine that the back button 903 has not been pressed (No), it proceeds to S718. Note that even in a case where the print dialog 1000 is closed without executing printing on the printer 13 in S715 or later, the process in S717 is performed in a case where the back button 903 has been pressed in S716.

In S717, the CPU 301 causes the printer portal application 411 to display the previous page linked to the screen ID of the previous page obtained in S712 on the in-app browser in response to the back button 903 being pressed in S716 and proceeds to S718. For example, the printer portal application 411 obtains, from the web server 11, the previous page corresponding to the URL obtained by replacing the screen ID included in the URL of the content selection site with the screen ID of the previous page obtained in S712. Then, the printer portal application 411 displays the previous page obtained from the web server 11. Note that as in the display method described in S713, it is also possible to upload a table with screen IDs and their corresponding URLs to the web server 11 so that the printer portal application 411 displays the previous page on the in-app browser in S717.

In S718, the CPU 301 causes the printer portal application 411 to determine whether an operation to terminate the in-app browser has been detected. In S718, if the CPU 301 causes the printer portal application 411 to determine that the operation to terminate the in-app browser has been detected (Yes), it terminates the in-app browser and ends this flow. In S718, if the CPU 301 causes the printer portal application 411 to determine that the operation to terminate the in-app browser has not been detected (No), it proceeds to S716. For example, the operation to terminate the in-app browser is, for example, pressing a button other than the content selection site display button 901 provided in the sidebar of the UI screen shown in FIG. 9, or an operation to terminate the printer portal application 411.

Note that in a case where the CPU 301 causes the printer portal application 411 to detect a press of the forward button 904 after S717, it goes without saying that the content page 900 that was originally displayed is displayed on the in-app browser.

According to this embodiment, even in a situation where some information cannot be shared between the web browser and the app, including the screen ID of the previous page in the launch instruction allows implementation of the function to return to the previous page in the in-app browser in a pseudo manner. This can reduce the deterioration of usability.

### Second Embodiment

The first embodiment has described a technique for implementing the function to return to the previous page in the in-app browser in a pseudo manner by the web browser including the screen ID of the previous page in the launch instruction. Specifically, it has described that a pseudo back button is implemented by including the screen ID of the previous page, which is the history information of the web browser, in the query part of the custom URL scheme and referring to the screen ID in the in-app browser. Here, since the printer portal application 411 receives history information from the web browser 421 and uses the received history information in the first embodiment, concerns remain from the perspective of privacy protection. Therefore, a second embodiment will be described as a technique for implementing a pseudo back button in an in-app browser with more emphasis on privacy protection.

This embodiment will describe a technique in which the printer portal application 411 obtains hierarchy information described later from the web server 11, thereby implementing a function to return to the previous page in the in-app browser in a pseudo manner. Note that since the basic configuration of this embodiment is similar to that of the first embodiment, the description of the details of the basic configuration is omitted. The following will describe the differences from the first embodiment.

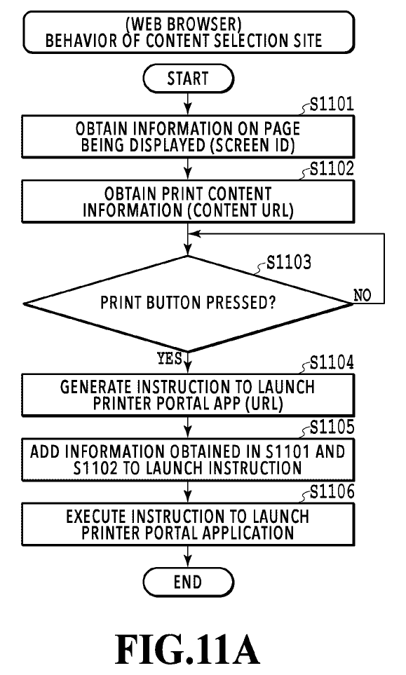

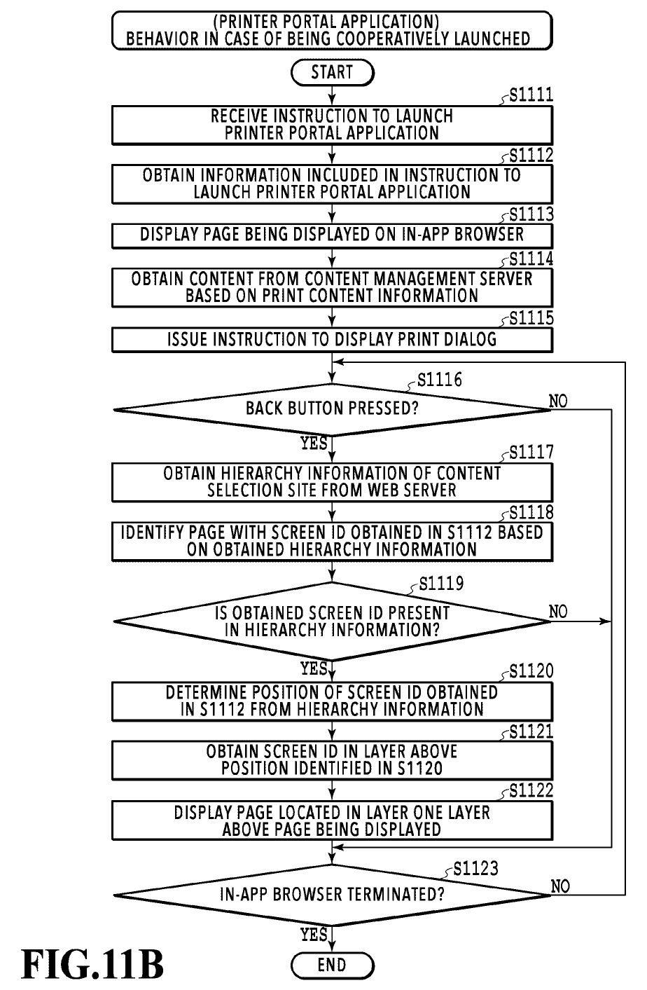

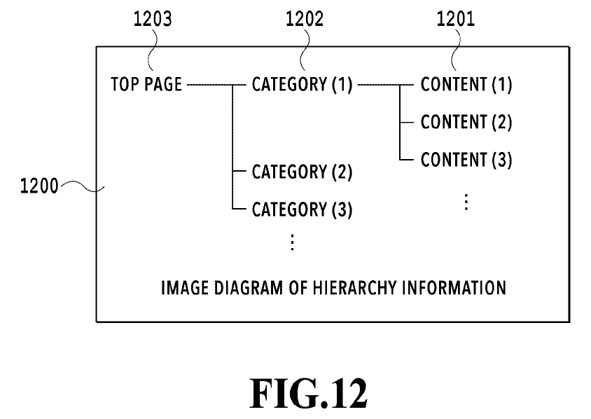

FIG. 11A and B are flowcharts showing an example of processing performed by the web browser 421 and the printer portal application 411 in this embodiment. Before the detailed description of FIG. 11, FIG. 12 will be discussed.

FIG. 12 is a diagram showing an example of hierarchy information 1200 of the content selection site. The hierarchy information 1200 is information indicating the hierarchical structure of the pages of the content selection site. Further, the web server 11 holds the hierarchy information 1200 shown in FIG. 12.

The hierarchy information 1200 is, for example, a map indicating the hierarchical structure of the pages of the content selection site as shown in FIG. 12. The hierarchical structure of the pages of the content selection site is divided into the following layers: a top page layer 1203, a category page layer 1202, and a content page layer 1201 as shown in FIG. 12.

Further, the hierarchy information 1200 includes information on the pages located in each layer. For example, the hierarchy information 1200 includes information on the page of a content (1) located in the content page layer 1201. The same applies to the page of a content (2) and the page of a content (3), as well as pages located in other layers. The information on the pages included in the hierarchy Information 1200 includes the screen IDs corresponding to the pages located in each layer. In other words, the hierarchy information 1200 allows grasping the relative position of each page in the hierarchical structure, identifying pages by matching screen IDs, and the like. Note that the hierarchy information 1200 may include information other than the screen IDs.

The top page layer 1203 is the top layer in the hierarchical structure of the pages of the content selection site. The category page layer 1202 is the middle layer in the hierarchical structure of the pages of the content selection site. In other words, the category page layer 1202 is one layer below the top page layer 1203. The content page layer 1201 is the bottom layer in the hierarchical structure of the pages of the content selection site. In other words, the content page layer 1201 is one layer below the category page layer 1202.

In a case where the user visits the content selection site, the top page located in the top page layer 1203 is displayed first, and a category page located in the category page layer 1202 is displayed according to the user's operation on the top page. The category pages are pages that are classified into categories of contents. Then, a content page located in the content page layer 1201 is displayed according to the user's operation on the category page. The content page is a page containing the content that the user desires to print. Note that the content page 800 of the content selection site shown in FIG. 8 is a content page located in the content page layer 1201 in the hierarchy information 1200.

FIG. 11A is a flowchart showing an example of processing performed by the web browser 421 in this embodiment. A flow of launching the printer portal application 411 from the content page displayed on the web browser 421 will be described with reference to FIG. 11A. Since the processes in S1101 and S1102 are similar to those in S701 and S703, respectively, in FIG. 7, which is the flowchart in the first embodiment, the description thereof is omitted. Furthermore, since the processes in S1103, S1104, and S1106 are similar to those in S704, S705, and S707, respectively, in FIG. 7, the description thereof is omitted.

In S1105, the CPU 301 causes the web browser 421 to include the screen ID obtained in S1101 and the print content information obtained in S1102 in the instruction to launch the printer portal application 411, and proceeds to S1106. Note that the launch instruction performed in S1106 differs from that in S707 of the first embodiment in that it does not include the screen ID of the previous page.

FIG. 11B is a flowchart showing an example of processing performed by the printer portal application 411 in this embodiment. A flow in which the printer portal application 411, which is launched in response to the launch instruction issued by the web browser 421, displays the previous page based on the obtained hierarchy information and the like will be described with reference to FIG. 11B. Since the processes in S1111 to S1116 are similar to those in S711 to S716, respectively, in FIG. 7, the description thereof is omitted. Note that the information obtained in S1112 differs from that in S712 of the first embodiment in that it does not include the screen ID of the previous page.

In S1117, the CPU 301 causes the printer portal application 411 to obtain the hierarchy information 1200 from the web server 11 and proceeds to S1118. Note that the hierarchy information 1200 may not be obtained from the web server 11. Further, the hierarchy information 1200 may be obtained using ways other than obtaining it from other servers including the web server 11.

In S1118, the CPU 301 causes the printer portal application 411 to identify the page corresponding to the screen ID obtained in S1112 based on the hierarchy information 1200 obtained in S1117 and proceeds to S1119. As mentioned above, the hierarchy information 1200 includes, for each page located in each layer, the page and its corresponding screen ID.

Thus, in S1118, the CPU 301 causes the printer portal application 411 to match the screens ID included in the hierarchy information 1200 with the screen ID obtained in S1112, thereby enabling identification of the page corresponding to the screen ID.

In S1119, the CPU 301 causes the printer portal application 411 to determine whether the screen ID obtained in S1112, that is, the screen ID of the page being displayed on the web browser is present in the hierarchy information 1200 or not based on the determination result in S1118. In S1119, if the CPU 301 causes the printer portal application 411 to determine that the screen ID obtained in S1112 is present in the hierarchy information 1200 (Yes), it proceeds to S1120. In S1119, if the CPU 301 causes the printer portal application 411 to determine that the screen ID obtained in S1112 is not present in the hierarchy information 1200 (No), it proceeds to S1123.

In S1120, the CPU 301 causes the printer portal application 411 to determine which layer in the hierarchy information 1200 the screen ID obtained in S1112 is located in, and proceeds to S1121. In other words, in S1120, the CPU 301 causes the printer portal application 411 to determine the position of the screen ID obtained in S1112 in the hierarchical structure indicated by the hierarchy information 1200.

In S1121, the CPU 301 causes the printer portal application 411 to obtain the screen ID in the layer one layer above the layer identified in S1120, and proceeds to S1122. In other words, in S1121, the CPU 301 causes the printer portal application 411 to obtain the screen ID in the layer one layer above the position identified in S1120.

For example, assume a case where the screen ID corresponding to the page of the content (1) in the content page layer 1201 in FIG. 12 is the screen ID of the page being displayed on the web browser. In this case, in S1121, the CPU 301 causes the printer portal application 411 to obtain the screen ID corresponding to the page of the category (1) in the category page layer 1202, which is the next higher layer.

In S1121, in a case where the CPU 301 causes the printer portal application 411 to obtain the screen ID in the layer one layer above the position identified in S1120, it transmits this screen ID to the web server 11. Then, the web server 11 identifies the page corresponding to the received screen ID and transmits it to the printer portal application 411. This allows the printer portal application 411 to obtain the previous page from the web server 11.

In S1122, the CPU 301 causes the printer portal application 411 to display the page corresponding to the screen ID obtained in S1121 on the in-app browser, and proceeds to S1123.

In S1123, the CPU 301 causes the printer portal application 411 to determine whether an operation to terminate the in-app browser has been detected. In S1123, if the CPU 301 causes the printer portal application 411 to determine that the operation to terminate the in-app browser has been detected (Yes), it terminates the in-app browser and ends this flow. In S1123, if the CPU 301 causes the printer portal application 411 to determine that the operation to terminate the in-app browser has not been detected (No), it proceeds to S1116. Note that if the CPU 301 causes the printer portal application 411 to determine (No) in S1119 and (No) in S1123, it does not proceed to S1116 but waits for the operation to terminate the in-app browser.

According to this embodiment, it is possible to implement the function to return to the previous page even in the in-app browser in a pseudo manner without passing information on the previous page from the web browser to the printer portal application as the user's history information. This makes it possible to reduce the deterioration of usability while protecting privacy even in situations where some information cannot be shared between the web browser and the app.

### Third Embodiment

The second embodiment has described a technique for implementing a function to return to the previous page in the in-app browser in a pseudo manner based on the hierarchy information obtained by the printer portal application 411 from the web server 11. Here, it is assumed that the user wishes for the browsing of the website related to the page being viewed, which is not limited to the page one page before the page being displayed on the web browser. For example, to check whether the content to be printed matches the user's desired content, the user may return to the top page once and makes a check on a website basis. In such a case, if it is only possible to transition from the page being displayed on the web browser to the previous page, the usability may deteriorate.

Therefore, this embodiment will describe a technique that enables the browsing of the website related to the page being displayed while protecting privacy as in the second embodiment. Note that since the basic configuration of this embodiment is similar to that of the second embodiment, the description of the details of the basic configuration is omitted. The following will describe the differences from the second embodiment.

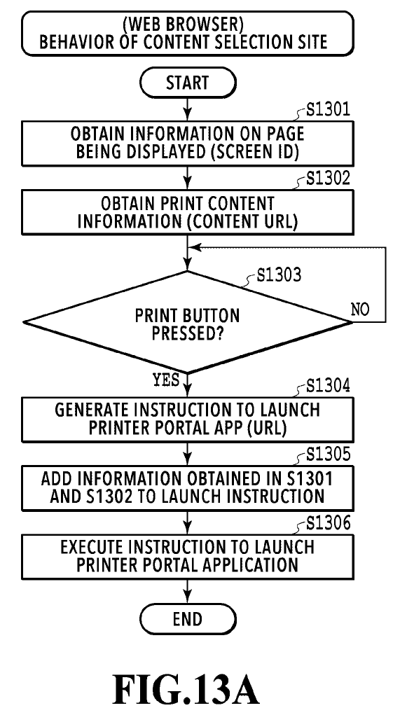

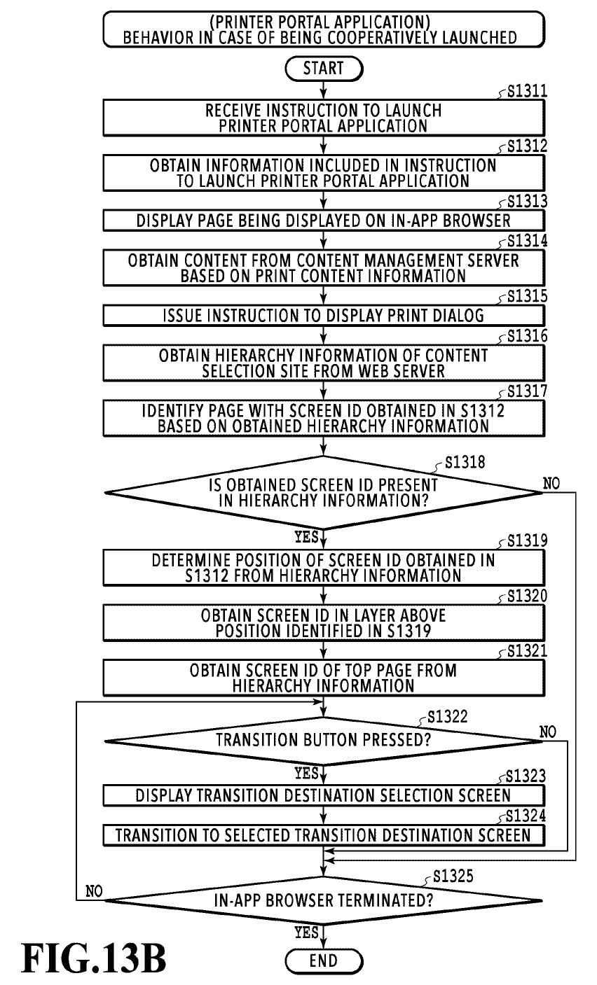

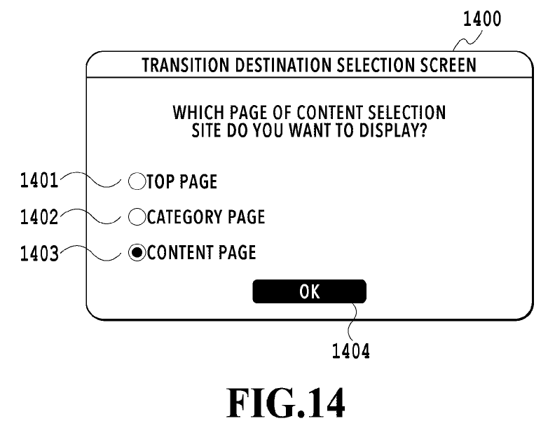

FIGS. 13A and B are flowcharts showing an example of processing performed by the web browser 421 and the printer portal application 411 in this embodiment. Before the detailed description of FIGS. 13A and B, FIG. 14 will be described.

FIG. 14 is a diagram showing an example of a transition destination selection screen 1400 that receives selection of a page that the user desires to transition to among the pages included in the content selection site. The transition destination selection screen 1400 is provided with a button 1401 that receives selection of the top page as the transition destination, a button 1402 that receives selection of a category page as the transition destination, and a button 1403 that receives selection of a content page as the transition destination. Further, the transition destination selection screen 1400 is provided with an OK button 1404 that receives an instruction to transition to the page corresponding to the selected button among the buttons 1401 to 1403. In a case where the OK button 1404 is pressed with one of the buttons 1401 to 1403 selected, the page corresponding to the selected button is displayed on the in-app browser.

The flowchart in FIG. 13A will be described. FIG. 13A is a flowchart showing an example of processing performed by the web browser 421 in this embodiment. Note that since the processes in S1301 to S1306 are similar to those in S1101 to S1106, respectively, in FIG. 11, which is the flowchart in the second embodiment, the description thereof is omitted.

The flowchart in FIG. 13B will be described. FIG. 13B is a flowchart showing an example of processing performed by the printer portal application 411 in this embodiment. A flow in which the printer portal application 411, which is launched in response to the launch instruction issued by the web browser 421, displays the user's desired page based on the obtained hierarchy information and the like will be described with reference to FIG. 13B. Note that since the processes in S1311 to S1315 are similar to those in S1111 to S1115, respectively, in FIG. 11, which is a flowchart in the second embodiment, the description thereof is omitted. Further, since the processes in S1316 to S1320 are similar to those in S1117 to S1121, respectively, in FIG. 11, which is the flowchart in the second embodiment, the description thereof is omitted.

In S1321, the CPU 301 causes the printer portal application 411 to obtain the screen ID of the top page located in the top layer included in the hierarchy information obtained in S1316, and proceeds to S1322. Note that although the printer portal application 411 obtains the screen ID of the top page from the hierarchy information in the S1321, the screen ID or URL of the top page may be obtained in other ways.

In the S1322, the CPU 301 causes the printer portal application 411 to determine whether a transition button (not shown) has been pressed or not. For example, the transition button is a button provided on the in-app browser instead of the back button 903 and the forward button 904 shown in FIG. 9, and is a button for receiving an instruction to display the transition destination selection screen 1400. Note that the transition button may be provided on the in-app browser separately from the back button 903 and the forward button 904.

In S1322, if the CPU 301 causes the printer portal application 411 to determine that the transition button has been pressed (Yes), it proceeds to S1323. In S1322, if the CPU 301 causes the printer portal application 411 to determine that the transition button has not been pressed (No), it proceeds to S1325.

In the S1323, the CPU 301 causes the printer portal application 411 to display the transition destination selection screen 1400 shown in FIG. 14 on the in-app browser. The user can select a transition destination page from the displayed transition destination selection screen 1400. For example, the user selects the button 1403 and presses the OK button 1404. Then, in a case where the CPU 301 causes the printer portal application 411 to detect the press of the OK button 1404 in S1322, it proceeds to the S1324.

In S1324, the CPU 301 causes the printer portal application 411 to transition to the page selected by the user in S1323. and proceeds to S1325. Note that the selected page is displayed based on the screen IDs obtained in S1312, S1320, and S1321. For example, the printer portal application 411 obtains, based on the screen IDs obtained in S1312, S1320, and S1321, the page corresponding to each of the screen IDs from the web server 11. Then, the printer portal application 411 displays the page corresponding to the page selected by the user in S1323 on the in-app browser.

In S1325, the CPU 301 causes the printer portal application 411 to determine whether an operation to terminate the in-app browser has been detected. In S1325, if the CPU 301 causes the printer portal application 411 to determine that the operation to terminate the in-app browser has been detected (Yes), it terminates the in-app browser and ends this flow. In S1325, if the CPU 301 causes the printer portal application 411 to determine that the operation to terminate the in-app browser has not been detected (No), it proceeds to S1322. Note that if the CPU 301 causes the printer portal application 411 to determine (No) in S1318 and (No) in S1325, it does not proceed to S1322 but waits for the operation to terminate the in-app browser.

This embodiment has described an example in which, in S1322, the CPU 301 causes the printer portal application 411 to display the transition destination selection screen 1400 in response to the press of the transition button. Note that the way to display the transition destination selection screen 1400 is not limited to this.

For example, after S1315 and after the print dialog 1000 is closed and then the processes in S1319 to S1321 are performed, the CPU 301 may cause the printer portal application 411 to display the transition destination selection screen 1400. In other words, in this case, even if the transition button is not pressed, the transition destination selection screen 1400 is displayed automatically.

According to this embodiment, it is possible to display the user's desired page on the in-app browser without passing the information on the previous page from the web browser to the printer portal application 411 as the user's history information. This makes it possible to reduce the deterioration of usability while protecting privacy even in situations where some information cannot be shared between the web browser and the app.

### Other Embodiments

The first embodiment has described an example in which the web browser 421 obtains the screen ID of the content page being displayed on the web browser 421, the screen ID of the previous page, and the print content information, and executes the launch instruction including the obtained information. Note that such processing may be performed by the web server 11.

For example, in the flowchart shown in FIG. 7A, in a case where the web browser 421 detects that the print button 801 has been pressed, it issues a request to generate a launch instruction. Here, the web browser 421 includes the history information of the content selection site and the URL scheme of the printer portal application 411 in the request to generate a launch instruction.

Then, the web server 11 identifies and obtains the screen ID of the content page being displayed on the web browser 421, the screen ID of the previous page, and the print content information from the history information included in the request to generate a launch instruction from the web browser 421.

After this, the web server 11 generates a launch instruction to launch the printer portal application 411 based on the URL scheme included in the request to generate a launch instruction from the web browser 421. Then, the web server 11 adds the obtained screen ID of the content page being displayed on the web browser 421 and the like to the generated launch instruction and transmits this launch instruction to the web browser 421.

In the flowchart shown in FIG. 7A, the web browser 421 executes the launch instruction received from the web server 11. Thus, the processing in which the web server 11 generates a launch instruction is not limited to the first embodiment, but also applicable to the second and third embodiments.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-021052, filed February 12, 2025, which is hereby incorporated by reference herein in its entirety.

What is claimed is:

1. A control method for an information processing apparatus performed by executing an application configured to provide a browser function, the control method comprising:
receiving information on a first web page displayed by a second web browser different from a first web browser provided by the application and information on a second web page displayed by the second web browser before the first web page;
displaying the first web page using the first web browser based on the received information on the first web page; and
based on selection of a predetermined object displayed with the first web page, displaying the second web page using the first web browser based on the information on the second web page,
wherein the application is an application launched based on a predetermined operation being performed in the second web browser.

2. The control method according to claim 1, wherein
the application is launched based on a launch instruction issued based on receiving the predetermined operation, and
the launch instruction includes the information on the second web page.

3. The control method according to claim 1, wherein the second web page is a page displayed by the second web browser immediately before the first web page.

4. The control method according to claim 1, wherein
a web server configured to transmit the first web page and the second web page has hierarchy information indicating a hierarchical structure of a plurality of web pages including the first web page and the second web page,
the second web page is located one layer above a layer corresponding to the first web page in the hierarchical structure,
the hierarchy information is obtained from the web server, and
the information on the second web page is obtained based on the hierarchy information and the information on the first web page.

5. The control method according to claim 4, wherein
the hierarchy information is obtained in response to an operation on the predetermined object, and
the second web page is displayed on the first web browser based on the information on the second web page.

6. The control method according to claim 4, wherein
the plurality of web pages further include a third web page different from the first web page and the second web page,
the third web page is located one layer above a layer corresponding to the second web page in the hierarchical structure,
information on the third web page is obtained based on the hierarchy information and the information on the first web page, and
a transition destination selection screen configured to allow selection of transition to one of the first web page to the third web page is displayed on the first web browser.

7. The control method according to claim 6, wherein a web page selected on the transition destination selection screen is displayed on the first web browser according to an operation on the transition destination selection screen.

8. The control method according to claim 1, wherein
the application is launched based on a launch instruction expressed with a custom URL scheme, and
a query part of the custom URL scheme includes the information on the first web page.

9. An information processing apparatus for executing an application configured to provide a browser function, the information processing apparatus comprising:
one or more processors; and
one or more memories storing instructions that, when executed by the one or more processors, cause the information processing apparatus to:
receive information on a first web page displayed by a second web browser different from a first web browser provided by the application and information on a second web page displayed by the second web browser before the first web page;
display the first web page using the first web browser based on the received information on the first web page; and
based on selection of a predetermined object displayed with the first web page, display the second web page using the first web browser based on the information on the second web page,
wherein the application is an application launched based on a predetermined operation being performed in the second web browser.

10. A non-transitory computer-readable storage medium storing a program for causing an information processing apparatus to execute a method, the information processing apparatus being configured to execute an application, the method comprising:
receiving information on a first web page displayed by a second web browser different from a first web browser provided by the application and information on a second web page displayed by the second web browser before the first web page;
displaying the first web page using the first web browser based on the received information on the first web page; and
based on selection of a predetermined object displayed with the first web page, displaying the second web page using the first web browser based on the information on the second web page,
wherein the application is an application launched based on a predetermined operation being performed in the second web browser.
